(19) United States
(12) Patent Application Publication
(10) Pub. No.: US 2019/0319419 A1
(43) Pub. Date: Oct. 17, 2019

(54) Device and Method for Manufacturing Wire for Wound Stator of Automotive Generator and Method

(71) Applicant: Victory Industrial Corporation, New Taipei City (TW)

(72) Inventors: Chun-Yuan WANG, New Taipei City (TW); Ching-Wei SUN, New Taipei City (TW)

(21) Appl. No.: 16/372,122

(22) Filed: Apr. 1, 2019

Related U.S. Application Data
(60) Provisional application No. 62/657,403, filed on Apr. 13, 2018.
(60) Provisional application No. 62/657,425, filed on Apr. 13, 2018.
(60) Provisional application No. 62/657,440, filed on Apr. 13, 2018.
(60) Provisional application No. 62/657,453, filed on Apr. 13, 2018.
(60) Provisional application No. 62/790,868, filed on Jan. 10, 2019.

(51) Int. Cl. H01R 43/28; H02K 15/085; H02K 15/04

(52) U.S. Cl. CPC H01R 43/28; H02K 15/0478; H02K 15/085

(57) ABSTRACT

The disclosure provides a device and a method for manufacturing a wire for a wound stator of an automotive generator. The wire includes a core and a coating surrounding the core. The wire manufacturing device includes a coating removing component, a movable holding component, a deforming component and a flattening component. The coating removing component is configured for removing the coating at a first position. The movable holding component is configured for holding and moving the wire from a first position to a second position. The deforming component is configured for deforming the wire into a waved shape. The flattening component is configured for flattening several parts of the wire that are spaced apart from each other.

### CROSS-REFERENCE TO RELATED APPLICATIONS

This applications claims the benefit of priority from the following US applications, each of which is herein incorporated by reference in their entirety for all purposes:

U.S. provisional patent application 62/657,403 filed Apr. 13, 2018;

U.S. provisional patent application 62/657,425 filed Apr. 13, 2018;

U.S. provisional patent application 62/657,440 filed Apr. 13, 2018;

U.S. provisional patent application 62/657,453 filed Apr. 13, 2018; and

U.S. provisional patent application 62/790,868 filed Jan. 10, 2019.

### TECHNICAL FIELD

The present disclosure generally relates to a device and a method for manufacturing a wire, and, more specifically to a device and a method for manufacturing a wire for a wound stator of an automotive generator.

### BACKGROUND

An alternating-current generator is used for converting mechanical energy into alternating-current electric energy. In terms of an alternating-current generator applied in a vehicle, an induced current is generated by the combined operation of a stator and a rotor driven by an engine. Specifically, the rotor includes a coil of wires wrapped around a metal core. Currents through the wire coil produce a magnetic field around the metal core. The strength of the field current determines the strength of the magnetic field. The field current may be a direct current supplied by brushes and slip rings. When an engine operates, the rotor is accordingly driven to rotate via a pulley coupled to the engine.

The magnetic field is formed by wires wound around a stator core to generate an induced electromotive force in the wires. An exemplary stator core is a cylinder with a number of teeth arranged on the inner circumferential side thereof. The wire is wound around several slots formed between the teeth. It is known that the magnitude of the magnetic field is determined by the density of the wire wound around the stator core and the quality of how the wire is wound around the slots. If the wire is disorderly arranged, the slot may have more air gaps, thereby resulting in magnetic resistance that may reduce the power generation efficacy.

In an existing method for manufacturing stators for alternating-current generators, a straight wire is manually bent around a jig to form a waved shape and then is cut off so that it has a predetermined length. Thereafter, the wave-shaped wire is manually inserted into the slots of a stator core. To manufacture these stators, numerous workers are needed and its cost is high and its efficiency is low. Furthermore, since the wire is cut off by hands, the length of each cut wire may be inconsistent. Thus, after the wire is wound around the stator core, another worker is required to trim all the wires to make them have approximately the same length and the trimmed wire sections are wasted. That being said, the conventional method is cumbersome, time-consuming, expensive, and may result in inconsistent quality of manufacture.

What are accordingly needed are a device and a method for manufacturing a wire for a wound stator of an automotive generator so that the wound stator may provide a better manufacturing quality and high power generation efficacy to the wound stator.

### SUMMARY OF INVENTION

In accordance with an embodiment of the present disclosure, a device for manufacturing a wire for a wound stator of an automotive generator is provided. The wire includes a core and a coating surrounding the core. The wire manufacturing device includes a coating removing component, a movable holding component, a deforming component and a flattening component. The coating removing component is configured for removing the coating at a first position. The movable holding component is configured for holding and moving the wire from the first position to a second position. The deforming component is configured for deforming the wire into a waved shape. The flattening component is configured for flattening several parts of the wire that are separate from each other.

In accordance with another embodiment of the present disclosure, a method for manufacturing a wire for a wound stator of an automotive generator is provided. The method is generally described as follows: a coating of a first section of the wire is removed at a first position. The wire is moved and held from the first position to a second position. A middle section of the wire is deformed into a waved shape such that the wire is formed of several straight portions and several U-shaped portions that alternate with each other. The coating of a second section of the wire is removed at the first position, and the middle section connects the first section and the second section. The first section, the middle section and the second section of the wire are cut off from the other part of the wire. The first section and the second section are then deformed into a waved shape.

In accordance with a further embodiment of the present disclosure, a method for manufacturing a wire for a wound stator of an automotive generator is provided. The method is generally described as follows: a wire including a core and a coating surrounding the core is provided. The wire is defined to have a first wire unit and a second wire unit, the first wire unit has a first section, a second section and a middle section between the first section and the second section. The coating of the first section is removed to expose the core thereof. The first section is held. Several parts of the middle section that are separate from each other is deformed to cause the middle section to form several straight portions and several U-shaped portions that alternate with each other into a waved shape. The coating on an end of the second section is removed. The wire is cut off to separate the first wire unit from the second wire unit. The first section and the second section are pressed to be deformed into a waved shape, respectively. The straight portions are pressed so that the cross-sections thereof are flattened.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 is a top view of a wire manufacturing system in accordance with an embodiment of the present disclosure;

FIG. 2 is an enlarged top view of a wire providing component, a coating removing component and a movable holding component of the wire manufacturing system in FIG. 1;

FIG. 3 is a top view of the wire manufacturing system in FIG. 1 wherein a deforming component is in operation.

FIGS. 4-5 are other top views of the deforming component in operation;

FIG. 6 is a top view showing a flattening component and a lifting component of the wire manufacturing system in FIG. 1;

FIG. 7 is a partial cross-sectional view of the flattening component of the wire manufacturing system in FIG. 1;

FIG. 8 is a partial cross-sectional view of the flattening component in operation; and

FIG. 9 is a wound stator with wires made by the wire manufacturing system in accordance with an embodiment of the present disclosure.

### DETAILED DESCRIPTION

The characteristics, subject matter, advantages, and effects of the present disclosure are detailed hereinafter by reference to embodiments of the present disclosure and the accompanying drawings. It is understood that the drawings referred to in the following description are intended only for purposes of illustration and do not necessarily show the actual proportion and precise arrangement of the embodiments. Therefore, the proportion and arrangement shown in the drawings should not be construed as limiting or restricting the scope of the present invention.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The present disclosure provides a wire manufacturing system for shaping a roll of wire into a wave shape (i.e., serpentine shape, sinusoidal shape or zig-zag shape) and flattening several parts of the wire, and a method of using the system to make such wire. The wire provided by the wire manufacturing system may be later wound around a stator core to form a wound stator for an automotive generator. In one embodiment, the automotive generator is, but not limited to, an alternating-current (AC) generator. The automotive generator may provide electrical power for several electronical parts installed in a vehicle, such as lamp, infrared sensor, air conditioner, radio device, rear-view camera, or the like.

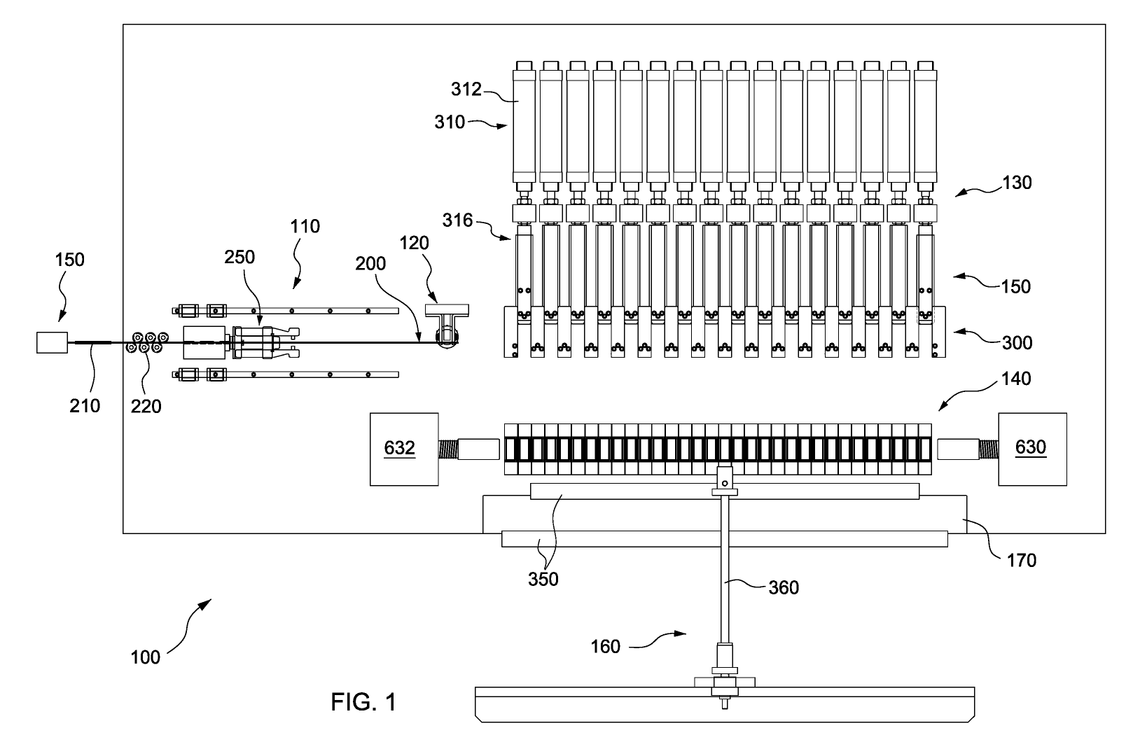

FIG. 1 is a top view of a wire manufacturing system in accordance with an embodiment of the present disclosure. In one embodiment, the wire manufacturing system 100 includes a coating removing component 110, a movable holding component 120, a deforming component 130 and a flattening component 140. In some embodiments, the wire manufacturing further includes a wire providing component 150 and a lifting component 160. The coating removing component 110 may be located between the wire providing component 150 and the deforming component 130, and the movable holding component 120 may be movably located above the deforming component 130. The flattening component 140 may be located next to the deforming component 130, and the lifting component 160 may be located over the flattening component 140 and the deforming component 130. The configuration of the wire manufacturing system 100 is not limited to the configuration described above and shown in FIG. 1. It should be apparent to a person skilled in the art that the wire manufacturing system 100 may have other configurations and layouts in other embodiments without departing from the spirit of this disclosure.

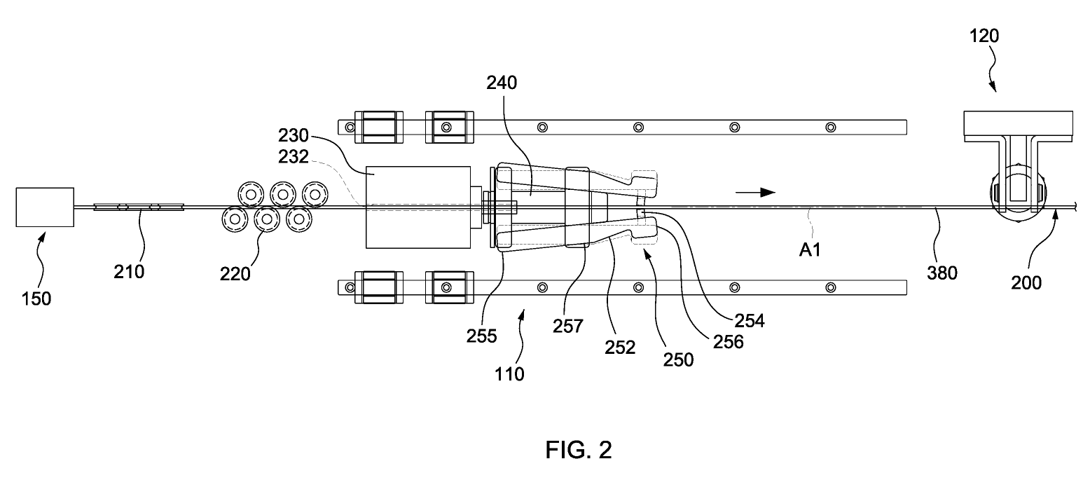

FIG. 2 is a top view of a wire providing component 150, a coating removing component 110 and a movable holding component 120 of the wire manufacturing system 100 in FIG. 1. The wire providing component 150 may be configured for providing and transporting a wire 200 to be processed. The wire providing component 150 may uncurl a roll of the wire (not shown) to become straight. In some embodiments, the wire 200 has a core mainly made of copper and a coating surrounding the core. The coating is made of an insulation material for preventing the core from being in contact with other parts of the stator. The insulation material may be, for example, polyurethane, polyurethane and polyamide, or polyester-imide. The wire providing component 150 may further include a first group of rollers 210 and a second group of rollers 220. The first group of rollers 210 is configured for further vertically straightening the wire 200. The second group of rollers 220 is configured for further horizontally straightening the wire 200. Accordingly, the wire 200 is straightened and then is smoothly transported to the coating removing component 110.

The coating removing component 110 may be configured for removing (i.e., striping) the coating of the wire 200. In some embodiments, the coating removing component 110 may include a motor 230, a base 240 and a stripper 250. The motor 230 and the base 240 provides a channel 232 therein for receiving the wire 200. The base 240 is connected to the motor 230 that is configured for driving the base 240 to spin around an axis A1 (see the dotted dash line shown in FIG. 2) aligned with the channel 232. The stripper 250 includes one or more arms 252 and one or more cutters 254. For example, the number of the arms 252 and that of the cutters 254 are both three. Each arm 252 has a first end 255, a second end 256, and a connecting section 257 between the first end 255 and the second end 256. The arms 252 are pivotally connected to the base 240 via the connecting section 257. The cutters 254 are mounted on the second ends 256 of the arms 252, respectively, and each cutter 254 faces toward the rotation axis A1. When the base 240 is driven by the motor 230 to spin, a centrifugal force is resulted from the rotation of the base 240 and the connecting section 257 serves as a fulcrum for each arm 252 to pivot about the connecting section 257. Consequently, the first ends 255 may move farther away from the axis A1, and the second ends 256 with the cutters 254 may move towards the axis A1 to strip the coating. Accordingly, a user can control the cutters 254 to remove (i.e., strip) the coating while the wire 200 keeps moving forward along the axis A1.

The movable holding component 120 may be configured for holding and moving the wire 200 from a position to another position. For example, the movable holding component 120 may hold and move a segment of the wire 200 from the coating removing component 110 onto the deforming component 130. The movable holding component 120 may include a holder for holding a small section of the wire 200, and a cutting unit, for example, a blade for cutting the wire 200 to split the wire 200 into two parts. The movable holding component 120 may include a rail (not shown) across the above of the deforming component 130. The holder and the cutting unit may be moved along the rail so as to go back and forth between the deforming component 130 and the coating removing component 110.

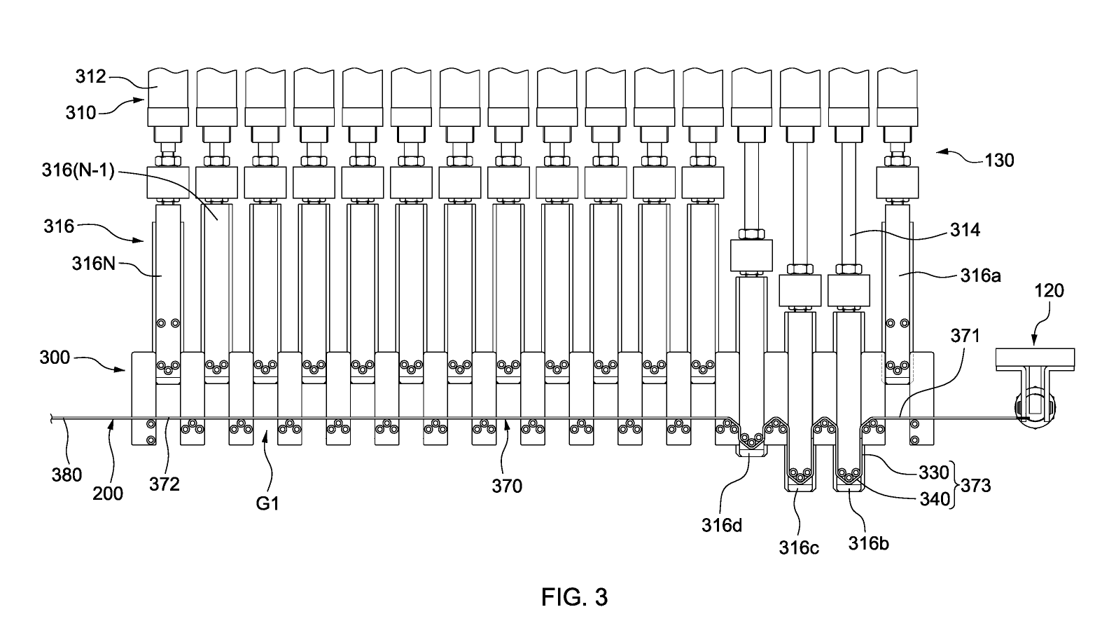

FIGS. 3-5 are top views of the deforming component 130 performing different steps. In some embodiments, the deforming component 130 may be configured for deforming the wire 200 into a wave shape. In some embodiments, the deforming component 130 may include several partitions 300 and several linear actuators 310. The partitions 300 may be spaced apart from each other by gaps G1 therebetween and substantially parallel to each other. Each partition 300 may include a main body 410 and a bending part 420 connected to the main body 410. The main body 410 may have two sides 412 and 414 that are opposite and parallel to each other.

The bending parts 420 may include several guiding wheels 422. For example, other than the two farthermost partitions 300 at the two sides of the deforming component 130, each of the bending parts 420 has three guiding wheels 422 thereon. Each group of the three guiding wheels 422 of the same bending parts 420 together forms a triangular shape. Specifically, in one group of the guiding wheels 422 on the same partition 300, there is one top guiding wheel 422a and two bottom guiding wheels 422b located on the two opposite sides of the bending parts 420. The triangular shape may be, but not limited to, an isosceles triangular shape. In some embodiments, the wire 200 to be processed may be placed to lean against the top guiding wheels 422a by the movable holding component 120.

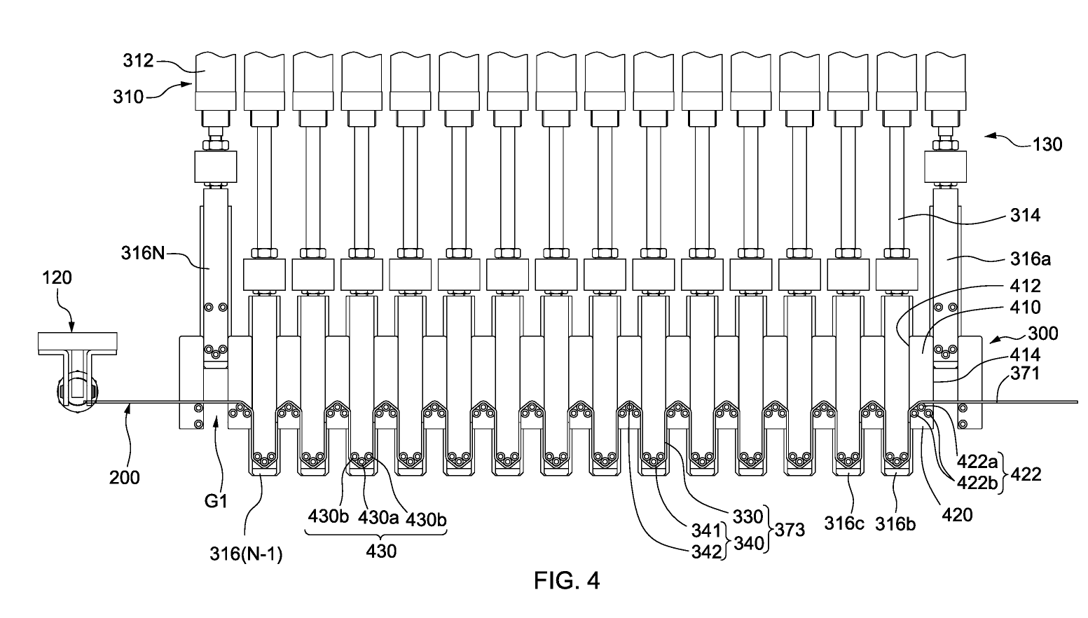

The linear actuators 310 may be configured for moving a part thereof into or out of the gaps G1 between the partitions 300 so as to press the wire 200 into a waved shape. In some embodiments, each linear actuator 310 includes a cylinder 312, a moving rod 314 and a curving part 316. In one embodiment, the linear actuators 310 are capable of moving the curving part 316 back and forth within the gaps G1 respectively. As shown in FIG. 4, each of the curving part 316 is in an elongated shape and has three guiding wheels 430 thereon at the front thereof. Each group of the three guiding wheels 430 of the same curving part 316 together forms an inverted triangular shape. Specifically, in one group of the guiding wheels 430 on the curving part 316, there is one bottom guiding wheel 430a and two top guiding wheels 430b located on the two opposite sides of the curving part 316. The inverted triangular shape may be, but not limited to, an isosceles triangular shape. The cylinder 312 is connected to an end of moving rod 314 for driving the moving rod 314 to expand or contract within the range between the cylinder 312 and the gap G1. The curving part 316 is connected to the other end of the moving rod 314. When the cylinder 312 drives the moving rod 314 to expand towards the gap G1 (the direction from top to bottom in FIG. 3), the curving part 316 moves downward. At the same time, a part of the straight wire 200 that faces the linear actuators 310 is pushed downward by the curving part 316 to deform. Accordingly, a part of the straight wire 200 is deformed to form one of a first group 341 of U-shaped (i.e., flection or curved) portions 340 of the wire 200.

In addition, when the linear actuator 310 is operated to drive the curving part 316 to enter into the gap G1, the portion of the wire 200 that is not deformed by the curving part 316, such as the portion that is not in contact with the guiding wheels 430a, 430b, forms two straight portions 330 along the two sides of the curving part 316 and are substantially parallel to each other. Two ends of each of the first group 341 of U-shaped portion 340 formed by the curving part 316 connects the two straight portions 330 of the wire 200.

As shown in FIGS. 3 and 4, on the other hand, when the curving part 316 enters into the respective gap G1 between two adjacent bending parts 420 of the partitions 300 and a part of the wire 200 is pushed by the guiding wheels 430a, 430b of the curving part 316 to form one of the first group 341 of U-shaped portions 340 of the wire 200, another part of wire 200 is pressed against the two adjacent bending parts 420 and is deformed (e.g., curved) into two of a second group 342 of U-shaped portions 340. Thus, each straight portion 330 may connect one end of each first group 341 of U-shaped portions 340 and one end of each second group 342 of U-shaped portions 340. Accordingly, the straight portions 330 and the U-shaped portions 340 that alternate with each other form a waved shape. The first group 341 and the second group 342 of the U-shaped portions 340 are formed on two opposite sides of a neutral axis (not shown) of the wave-shaped wire 200.

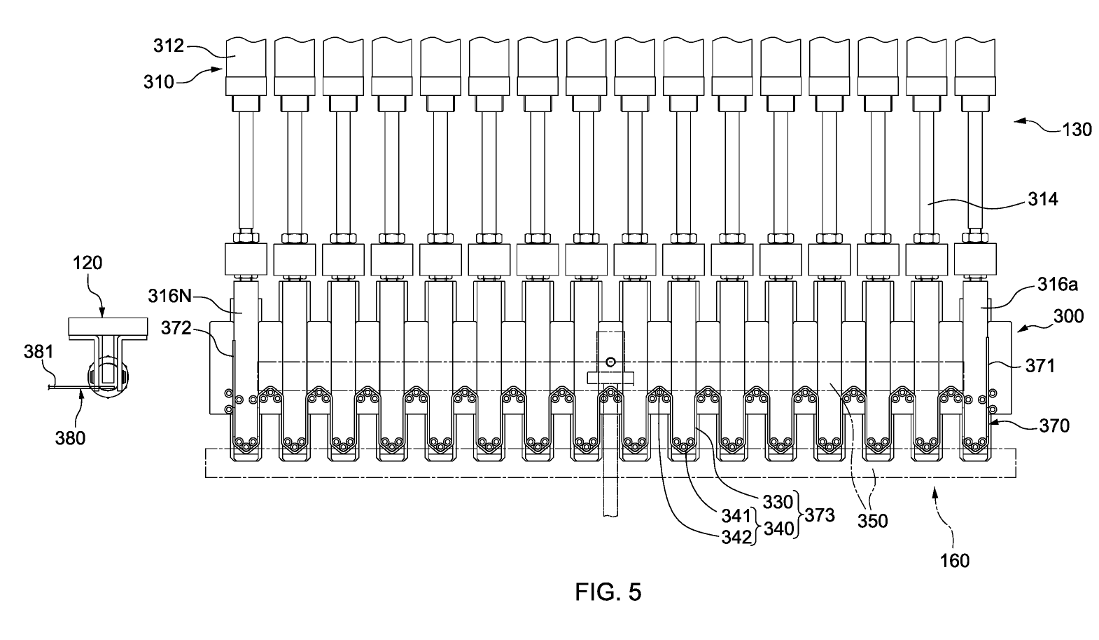

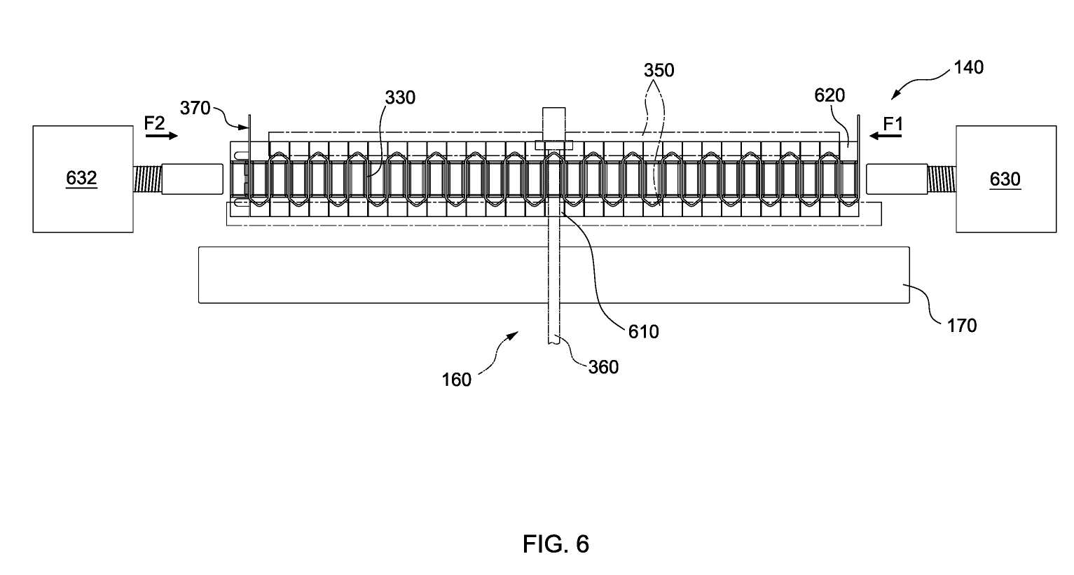

FIG. 6 is a top view of a flattening component 140 and a lifting component 170 of the wire manufacturing system 100 in FIG. 1. FIG. 7 is a partial cross-sectional view of the flattening component 140 of the wire manufacturing system 100 in FIG. 1. In some embodiments, the flattening component 140 may be configured for flattening several parts of the wire 200 that are spaced apart from each other. In one embodiment, the flattening component 140 may include a fixed block 610 mounted around the middle of the flattening component 140, and several sliding blocks 620 positioned at two opposite sides of the fixed block 610. The fixed block 610 and the sliding blocks 620 are arranged in a row and separated by several intervals G2, respectively. The sliding blocks 620 may be configured for being moved towards and away from the fixed block 610 such that the widths of the intervals G2 may be varied when the sliding blocks 620 is moved. The fixed block 610 includes two grooves 710 and 720 on its two opposite sides. Each sliding block 620 may include a groove 730 on a side facing farther away from the fixed block 610. The grooves are next to the respectively intervals G2, respectively. Each of the grooves 710, 720 and 730 may be configured for receiving the straight portions 330 of the wire 200. The diameter of the wire 200 is greater than the widths of the grooves 710, 720 and 730. Thus, when the straight portions 330 are placed into the grooves 710, 720 and 730, the straight portions 330 may occupy the whole grooves 710, 720 and 730 and a part of the intervals G2.

In one embodiment, the sides of the sliding blocks 620 may be tapered from the bottom thereof towards the top for guiding the insertion of the straight portions 330 of the wire 200 into the grooves 710, 720 and 730. The edges of the sliding blocks 620 may be rounded.

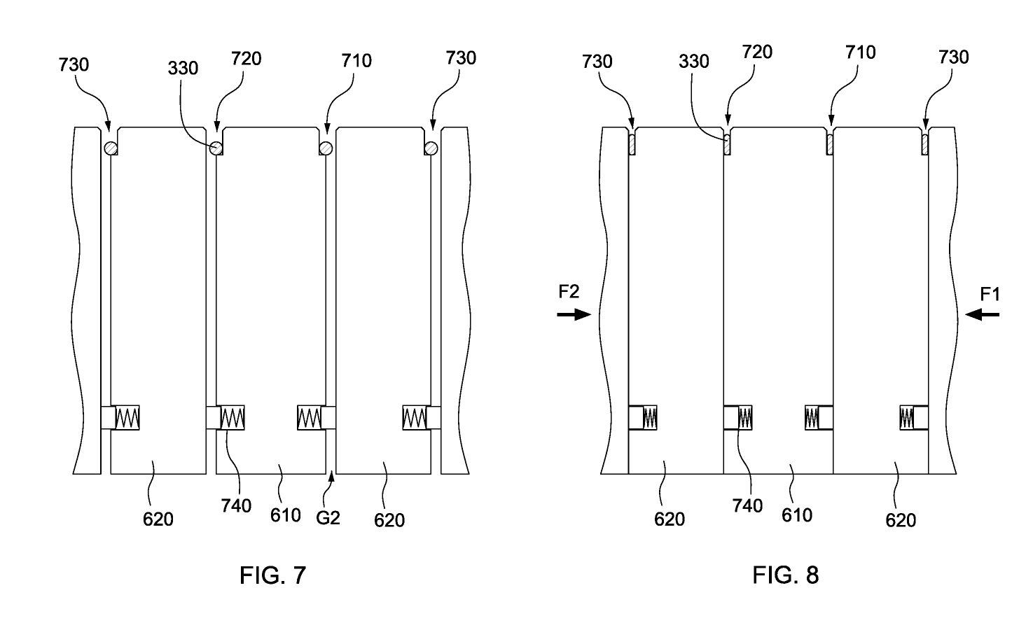

In one embodiment, the flattening component 140 may further include two pushing units 630 and 632 adjacent to two opposite sides of the whole set of sliding blocks 620, respectively. That is, the sliding blocks 620 and the fixed block 610 are located between the two pushing units 630 and 632. The two pushing units 630 and 632 are configured for pushing the sliding blocks 620 towards the fixed block 610 in a direction that the wire 200 extends so as to flatten the straight portions 330 of the wire 200. As shown in FIG. 7, the direction that the wire 200 extends is a horizontal direction, and thus the straight portions 330 may be pressed horizontally by two opposing forces F1, F2, as illustrated in FIGS. 6 and 8, which is a partial cross-sectional view of the flattening component 140.

The flattening component 140 may further include several elastic units 740 positioned between every two of the fixed block 610 and the sliding blocks 620 that are adjacent to each other. The elastic units 740 are configured for exerting a biasing force in response to a force applied by the two pushing units 630 and 632. For example, the pushing units 630 and 632 may be linear actuators driven by motor(s).

In some embodiments, the lifting component 160 may be configured for moving above the deforming component 130 and the flattening component 140 for transporting the wire 200 from the deforming component 30 to the flattening component 140. As shown in FIGS. 5 and 6, in some embodiments, the lifting component 160 may include a pair of claws 350 for picking up and place the wire 200, and a guide bar 360 that the claws 350 are coupled thereto and may move along with. The lifting component 160 may be actuated to move downward to pick the wave-shaped wire 200 with the claws 250 from the deforming component 130, move along the guide bar 360 to the above of the flattening component 140, and place the straight portions 330 of the wave-shaped wire 200 into the grooves 710, 720, 730 of the flattening component 140, as shown in FIG. 7.

As shown in FIG. 1, the wire manufacturing system 100 may further include a belt conveyor 170 adjacent to the flattening component 140. After the straight portion 330 of the wire 200 is flattened by the flattening component 140, the lifting component 160 may pick up the flattened wire 200 to the belt conveyor 170. The belt conveyor 170 may transport the ultimately finished wire 200 to a container (not shown) for next manufacturing process, for example, inserting the wire into numerous slots of a stator core.

The following describes a method for manufacturing a wire 200 for a wound stator of an automotive generator. As shown in FIG. 2, first, a wire 200 is provided from the wire providing component 150 that uncurls a roll of wire 200 into a straight wire. Furthermore, the two groups of rollers 210 and 220 may shape the wire 200 to become straight. The wire 200 includes a core and a coating surrounding the core. In addition, as shown in FIG. 3, the wire 200 may be defined to have several wire units, including a first wire unit 370 and a second wire unit 380 extending form the first wire unit 370. Each first and second wire units having a first section, a second section and a middle section between the first section and the second section. For example, as shown in FIG. 3, the first section 371 is at the right side of the first wire unit 370, and the second section 372 is at the left side of the first wire unit 370. The middle section 373 of the first wire unit 370 is between the first section 371 and the second section 372. In some embodiments, when the first wire unit 370 is carried to the deforming component 130, the second wire unit 380 is carried to the coating removing component 110.

Then, as shown in the dotted lines of FIG. 2, a part of the coating of a first section 371 of the first wire unit 370 is removed at a first position. In some embodiments, the coating of the first section 371 is removed by the stripper 250 in order to expose the core of the first section 371. The exposure of the core is used for further electrical connection to another wire in series or in parallel. In addition, the end of the first section 371 is held by the movable holding component 120 such that the first wire unit 370 may be held firmly and horizontally.

Then, as shown in FIG. 3, the wire 200 is moved and held from the first position to a second position by the movable holding component 120. In some embodiments, the movable holding component 120 holds the first section 371 of the first wire unit 370 to the right side of the deforming component 130, and the middle section 373 of the wire 200 leans against the tops of the partitions 300.

In addition, when coatings on the certain parts of the wire 200 are required to be removed, these coatings can be removed while the parts of the wire 200 are passing through the stripper 250. In some embodiments, while the movable holding component 120 moves the wire 200 from the first position to the second position, the coating of the second section 372 of the first wire unit 370 and a portion of the second wire unit 380 connected to the above-mentioned second section 372 of the first wire unit 370 may be being removed by the stripper 250.

Afterwards, the linear actuators 310 are driven to push the curving parts 316 to deform the wire 200 to form several U-shaped portions 340. Also, several straight portions 330 are formed along the sides of the curving parts 316. In some embodiments, the curving parts 316, from the right side to the left side of FIG. 4, are defined as a first curving part 316a (i.e., the rightmost curving part), a second curving part 316b, a third curving part 316c, . . . a Nth curving part 316N (i.e., the leftmost one).

In this step, several parts of the middle section 373 that are spaced apart from each other may be pressed sequentially from the side of the first section 371 towards the side of the second section 372 by moving the curving parts 316 of the linear actuators 310 to enter into the gaps G1 between the partitions 300, respectively. In some embodiments, the first curving part 316a corresponds to the first section 371, the last (Nth) curving part 316N (i.e., the leftmost curving part) corresponds to the second section 372, and all of the curving parts 316 other than the first curving parts 316 and the last (Nth) curving parts 316N correspond to the middle section 373. In one embodiment, it is the second curving part 316b (i.e., the second-from-the-right curving part) that firstly presses against the wire 200. At this time, since the first section 370 of the wire 200 is tightly held by the movable holding component 120, when the wire 200 is pressed by the second curving part 316b, only the left side of the wire 200 is pulled into the gap G1. This is because the lengthwise deformation of the wire 200 is limited and if the left side (the second section 372) of the wire 200 is also tightly held, when a part of the wire 200 is pressed into the gap G1, the wire 200 may be undesirably deformed or even split into two pieces. Thus, one side of the wire 200 should be loose for preventing the wire 200 from being damaged. On the other hand, if both the two ends of the first wire unit 370 are not held (free ends), when the wire unit 370 is pressed by the curving parts 316 of the linear actuators 310, it is arduous to properly and precisely form straight portions 330 and U-shaped portions 340 at the desired segments of the wire 200.

In some embodiments, after the second curving part 316b is moved into the gap G1 to press the wire 200, the third curving part 316c which is at the left side of second curving part 316b is moved into its respective gap G1. Then, the fourth curving part 316d which is at the left side of third curving part 316c is moved into its respective gap G1 after the third curving part 316c stops moving. As illustrated in FIG. 4, similarly, other curving parts 316, from the right side to the left side, are sequentially moved into their respective gap G1 until the (N-1)th curving part 316(N-1) is moved into its respective gap G1. The second group 342 of the U-shaped portions 340 that corresponds to the bending parts 420 of partitions 300 is formed when the two adjacent curving parts 316 (for example, the second and third curving parts 316b and 316c) are moved into their respective gaps G1. At this time, the step of deforming the middle section 373 of the first wire unit 370 to form straight portions 330 and U-shaped portions 340 that alternate with each other is finished.

After the second curving part 316b is moved into the gap G1, the right end of the middle section 373 of the first wire unit 370 is held by the second curving part 316b. At this time, the movable holding component 120 may release the first section 371 of the first wire unit 370 in that the second curving part 316b takes over the movable holding component 120 to hold the right side of the first wire unit 370. Then, the movable holding component 120 may move across the deforming component 130 from the right side to the left side of the deforming component 130 to hold the second section 372 of the first wire unit 370.

As illustrated in FIG. 5, afterwards, the movable holding component 120 may cut off the joint between the second section 372 of the first wire unit 370 and the second wire unit 380 so as to separate the first wire unit 370 from the second wire unit 380. At this time, the second section 372 of the first wire unit 370 is not held by the movable holding component 120; a first section 381 of the second wire unit 380 is still held by the movable holding unit 120. In other words, instead of being held by the movable holding component 120, the two ends of the first wire unit 370 are held by the first curving part 316a and the Nth curving part 316N of the deforming component 130 in the gaps G1, respectively. Furthermore, in some embodiments, because the coatings of the second section 372 of the first wire unit 370 and the first section 381 of the second wire unit 380 are removed when the second section 372 of the first wire unit 370 and the first section 381 of the second wire unit 380 are passing through the coating removing component 110, the cores at the second section 372 of the first wire unit 370 and the first section 381 of the second wire unit 380 are exposed to the outside for electrical connection with other wire units.

Furthermore, the first section 371 and the second section 372 of the first wire unit 370 are pressed by the first curving part 316a and the Nth curving part 316N so as to form the two ends of the first wire unit 370 into U-shaped portions 340 and straight portions 330. At this time, the two ends of the first wire unit 370 are not held by the movable holding component 120, and thus the two ends of the first wire unit 370 can be pushed into their respective gaps G1 by the first curving parts 316a and the Nth curving parts 316N without damaging the first wire unit 370 or splitting it into two or more pieces. Accordingly, the step of deforming the middle section 373, the first section 371 and the second section 372 to form the first wire unit 370 in a waved shape is finished.

In one embodiment, the pressing of the first curving part 316a and the Nth curving part 316N may be performed simultaneously. Alternatively, the first curving part 316a is pressed before or after the Nth curving part 316N is pressed.

Afterwards, as shown in FIGS. 5-6, the claws 350 of the lifting component 160 may pick up the first wire unit 370 from the deforming component 130 and move it to the flattening component 140 along the guide bar 360. Then, the claws 350 may place the straight portions 330 of the first wire unit 370 into the grooves 710, 720 and 730, as shown in FIG. 7.

The straight portions 330 of the middle section 370 may be flattened in a direction which the wire 200 extends. In some embodiments, the two pushing units 630 and 632 at two sides of the flattening component 140 exerts two forces F1, F2 to push the sliding blocks 620 towards the fixed block 610. The intervals G2, which are between the two adjacent sliding blocks 620, or between the fixed block 610 and its adjacent sliding block 620, may be diminished to zero such that the sliding blocks 620 may press the sides of the straight portions 330. The straight portions 330 are pressed so that their cross-sections are flattened. In some embodiments, the cross-sections of the straight portions 330 are reshaped from circular shape into rectangular shape, or oval (elliptical) shape. In other embodiments, the cross-section of the straight portion 330 may be reshaped to other configurations. In some embodiments, since the cross-sections of the straight portions 330 are flattened, when several straight portions 330 are serially arranged in a slot of a stator core, the shape of the flattened straight portions 330 may be better fitted to each other such that the air gap in the slot is minimized. Besides, such slot is able to accommodate more wires 200 with flattened straight portions 330 than conventional wires 200 with round straight portions, which enhances the magnitude of the magnetic field. Hence, the magnetic resistance resulted from the air gaps may be reduced, thereby diminishing magnetic resistance.

In some embodiments, the flattening component 140 includes the two pushing units 630 and 632 located on two opposite sides of the body of the flattening component 140, respectively. If there is only one pushing unit located on one side of the flattening component 140, the one pushing unit requires a larger power to push all of the sliding block 620 from one side to the opposite side to flatten all straight portions 330. Compared to the one-pushing-unit system, each of the two pushing units 630 and 632 in some embodiments of this disclosure only needs to push a half of the sliding blocks 620 towards the fixed block 610 located around the middle of the flattening component 140, and thus a lower power is required. Further, the working distance of the two pushing units 630 and 632 is shorter as compared to the one-pushing-unit system, so that the wire 200 can be flattened in this system faster than in the conventional one-pushing-unit system.

As illustrated in FIGS. 6 and 8, when the pushing units 630 and 632 apply forces F1 and F2 to press the sliding blocks 620 towards the fixed blocks 610, the elastic units 740 positioned between the fixed block 610 and the sliding block 620, or between the two adjacent sliding blocks 620, are also compressed. When the pushing units 630 and 632 stop pressing the sliding blocks 620 and return to their original positions, each elastic unit 740 may exert a biasing force in response to the force applied by the two pushing units 630 and 632 with a view to pushing all of the sliding blocks 620 back to their original positions.

As illustrated in FIG. 6, after the straight portions 330 of the first wire unit 370 are flattened, the lifting component 160 may pick up the first wire unit 370 from the flattening component 140 to the belt conveyor 170. The belt conveyor 170 may carry the first wire unit 370 to a container (not shown) for a next manufacturing process, such as winding the first wire unit 370 to a stator core.

In addition, when the flattening component 140 is flattening the straight portions 330 of the first wire unit 370, the deforming component 130 may, at the same time, perform the step of deforming the second wire unit 380, and the coating removing component 110 may, at the same time, receive a third wire unit extending from the other end of the second wire unit 380. That is, the wire manufacturing system 100 may simultaneously perform different steps on different wire units located at different stations of the system 100, thereby increasing manufacturing efficiency.

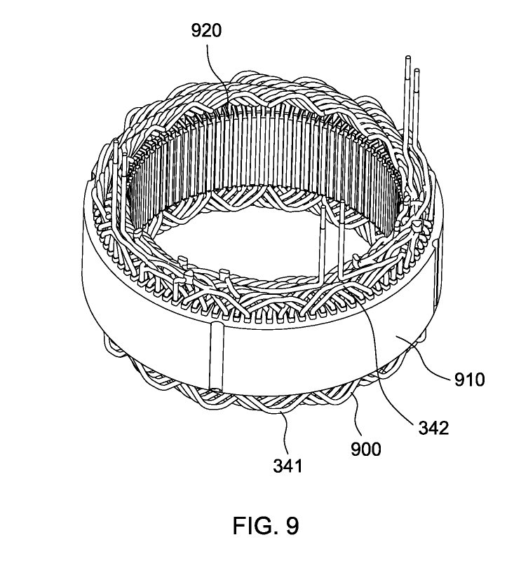

FIG. 9 is a wound stator with wire units 900 made by the wire manufacturing system 100 in accordance with one embodiment of the present disclosure. Each wire unit 900 may be inserted into numerous slots 910 of a stator core 920. For example, the stator core 920 has 96 slots 910 evenly formed in the inner circumferential surface of the stator core 920. For example, in one wire unit, the number of the first groups 341 of U-shaped portions 340 is sixteen, and the number of the second groups 342 of U-shaped portions 340 is fifteen. Half of a wire unit 900 may be inserted into slots 910 by an interval. Then the other half of the wire unit 900 may be twisted into an opposite direction and inserted into the inserted slots 910 again. This means the same wire unit 900 may be inserted into the same slot 910 for two times. Further, each slot 910 may accommodate several different wire units 900, for example, two or more layers of wire units.

In conclusion, the wire manufacturing device disclosed in an embodiment of the disclosure may automatically manufacture numerous wave-shaped wires including several flattened straight portions and several U-shaped portions that alternate with each other from a roll of wire. Factory workers may not concentrate on manufacturing wires after a long period of working time, and thus the quality may not be consistent, which reduces the power generation efficacy of the manually-made stator. Therefore, in the absence of any manual process, the wires made by the foregoing wire manufacturing device and method provide a superior quality and better power generation efficacy to a stator using the same.

Additionally, in accordance with an embodiment of the disclosure, as a wire is cut off into wire units automatically, the length of each wire unit is consistent. Conventional methods of manually cutting off a wire and removing the coating of the wire usually result in inconsistent length of the wire units, which lead to material waste. In contrast, the instant disclosure avoids such material waste as it provides a precise wire cutting.

Furthermore, the step of removing the coating is performed before the wire is deformed to a waved shape, and the coating removing component may remove one end of a wire unit and one end of another wire unit simultaneously, it saves manufacturing time. The removing of the coating may be more consistent compared to an existing method wherein the coatings are removed by hand.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A device for manufacturing a wire for a wound stator of an automotive generator, the wire including a core and a coating surrounding the core, the wire manufacturing device comprising:
a coating removing component configured for removing the coating at a first position;
a movable holding component configured for holding and moving the wire from the first position to a second position;
a deforming component configured for deforming the wire into a waved shape; and
a flattening component configured for flattening a plurality parts of the wire that are separate from each other.

2. The device of claim 1, further comprising a wire providing component configured for providing and transporting the wire;

3. The device of claim 1, wherein the deforming component includes a base plate, a plurality of partitions on the base plate, and a plurality of linear actuators, the plurality of partitions is separate from each other by gaps therebetween and substantially parallel to each other.

4. The device of claim 3, wherein the linear actuator includes a cylinder, a moving rod and a curving part, wherein the curving part is in an elongated shape, the cylinder is connected to an end of moving rod for driving the moving rod to expand or contract within the range between the cylinder and the gap, and the curving part is connected to the other end of the moving rod and is configured for deforming the wire to form a first group of U-shaped portions.

5. The device of claim 4, wherein each partition includes a main body and a bending part connected to the main body, the main body has two sides that are opposite to each other, wherein the bending part of the partition and the curving part of the liner actuator includes a plurality of guiding wheels. .

6. The device of claim 5, wherein when the curving part is driven to enter into the gap between two adjacent bending parts of the partition, a part of the wire is pushed by the curving part to form one of the first group of U-shaped portions of the wire, and another part of the wire is pressed against the two adjacent bending parts to form a second group of U-shaped portions.

7. The device of claim 5, wherein each of the plurality of bending parts and the plurality of curving parts includes three guiding wheels for guiding the wire to be curved, each group of the three guiding wheels of the plurality of bending parts and the plurality of curving parts forms a triangular shape or an inversed triangular shape.

8. The device of claim 1, wherein the flattening component includes a bottom plate, a fixed block mounted on around the middle of the bottom plate, and a plurality of sliding blocks disposed on the bottom plate and are provided at two sides of the fixed block wherein the fixed block and the plurality of sliding blocks are arranged in a row and are separated by grooves, each of the grooves being configured for receiving the plurality of straight portions of the wire.

9. The device of claim 8, wherein the flattening component further includes two pushing units adjacent to two opposite sides of the bottom plate, respectively, the two pushing units are configured for pushing the plurality of sliding blocks towards the fixed block in a direction that the wire extends so as to flatten the plurality of straight portions, the flattening component further includes a plurality of elastic units between two of the fixed block and the plurality of sliding blocks that are adjacent to each other and configured for exerting a biasing force in response to a force applied by the two pushing units.

10. The device of claim 8, wherein the sides of the plurality of sliding blocks are tapered towards a direction farther away from the bottom plate for guiding the insertion of the wire.

11. The device of claim 1, wherein the coating removing component includes a stripper and a motor, the stripper includes an arm and a cutter mounted on an end of the arm, the motor is configured for driving the stripper to rotate, allowing the cutter to move towards the central axis of the stripper by a centrifugal force produced by the rotation.

12. The device of claim 1, further comprising a lifting component configured for transporting the wire from the deforming component to the flattening component.

13. A method for manufacturing a wire for a wound stator of an automotive generator, the method comprising:
removing a coating of a first section of the wire at a first position;
moving and holding the wire from the first position to a second position;
deforming a middle section of the wire into a waved shape such that the wire is formed of a plurality of straight portions and a plurality of U-shaped portions that alternate with each other;
removing the coating of a second section of the wire at the first position, the middle section connecting the first section and the second section;
cutting off the first section, the middle section and the second section of the wire from the other part of the wire; and
deforming the first section and the second section into a waved shape.

14. The method of claim 13, further comprising flattening the straight portions of the middle section in a direction which the wire extends.

15. A method for manufacturing a wire for a wound stator of an automotive generator, the method comprising:
providing a wire including a core and a coating surrounding the core, the wire being defined to have a first wire unit and a second wire unit, the first wire unit having a first section, a second section and a middle section between the first section and the second section;
removing the coating of the first section to expose the core thereof;
holding the first section;
pressing a plurality of parts of the middle section that are spaced apart from each other to deform the middle section to form a plurality of straight portions and a plurality of U-shaped portions that alternate with each other into a waved shape;
removing the coating on an end of the second section;
cutting off the wire to separate the first wire unit from the second wire unit;
pressing the first section and the second section to deform the first section and the second section into a waved shape, respectively; and
pressing the plurality of straight portions to flatten the cross-sections thereof

16. The method of claim 15, wherein the step of pressing the middle section into the waved shape to form the plurality of straight portions and the plurality of U-shaped portions that alternate with each other further comprises:
pressing a plurality of parts of the middle section sequentially from the side of the first section towards the side of the second section.

17. The method of claim 16, wherein the step of pressing the middle section into the waved shape to form the plurality of straight portions and the plurality of U-shaped portions that alternate with each other further comprises:
pressing the plurality of parts of the middle section sequentially from the side of the first section towards the side of the second section by moving curving parts of a plurality of linear actuators into a plurality of gaps between a plurality of partitions, respectively.

18. The method of claim 15, wherein the step of removing the coating on the end of the second section further comprises:
simultaneously removing the coating on the end of the second section of the first wire unit and a first section of the second wire unit extending from the second section of the first wire unit.

19. The method of claim 15, prior to the step of pressing the first section and the second section to deform the first section and the second section into the waved shape, respectively, further comprising:
releasing the first section.

20. The method of claim 15, wherein the step of pressing the plurality of straight portions to flatten the cross-section thereof further comprises:
pressing the plurality of straight portions in a direction that the wire extends.
